(19) United States
(12) Patent Application Publication
(10) Pub. No.: US 2020/0005331 A1
(43) Pub. Date: Jan. 2, 2020

(54) INFORMATION PROCESSING DEVICE, TERMINAL DEVICE, INFORMATION PROCESSING METHOD, INFORMATION OUTPUT METHOD, CUSTOMER SERVICE ASSISTANCE METHOD, AND RECORDING MEDIUM

(71) Applicant: NEC Corporation, Tokyo (JP)

(72) Inventor: Kazuyoshi WARITA, Tokyo (JP)

(73) Assignee: NEC Corporation, Tokyo (JP)

(21) Appl. No.: 16/489,921

(22) PCT Filed: Mar. 1, 2018
(86) PCT No.: PCT/JP2018/007700

§ 371 Date: Aug. 29, 2019

(30) Foreign Application Priority Data
Mar. 3, 2017 (JP) 2017-040660

(51) Int. Cl. G06Q 30/00; G06K 9/00; G06Q 30/02

(52) U.S. Cl. CPC G06Q 30/016; G06Q 30/0201; G06K 9/00671

(57) ABSTRACT

An information processing device (210) comprises the following: an acquisition unit (211) for acquiring first information indicating a position; an identification unit (212) for identifying a target present within a prescribed range from the position, using the first information acquired by the acquisition unit (211); a generation unit (213) for generating second information relating to the target identified by the identification unit (212), using third information indicating the movement history of the target; and an output unit (214) for outputting the second information generated by the generation unit (213).

### TECHNICAL FIELD

The present disclosure relates to an information processing device and the like and, for example, relates to an information processing device that generates flow line information of a customer in a store.

### BACKGROUND ART

Various technologies for generating or analyzing flow lines of customers having visited a store and the like have been known (for example, see PTLs 1 to 3). The technologies described in PTLs 1 to 3 are used for recording flow lines and utilizing information obtainable from the recorded flow lines in an after-the-fact manner. For example, the technology described in PTL 1 is used for understanding an overall trend of customers in a store and making use of the trend data in the layout and the like of sales spaces. In other words, the technology described in PTL 1 uses flow lines of a plurality of customers statistically.

### CITATION LIST

### Patent Literature

[PTL 1] JP 2014-067225 A

[PTL 2] JP 2005-071252 A

[PTL 3] JP 2006-185293 A

### SUMMARY OF INVENTION

### Technical Problem

While there is a certain overall trend in purposes of visits to a store by customers, such purposes can differ from customer to customer. There have occurred cases where, when a store clerk performs customer service based on statistical information to a customer who has visited the store with some purpose (that is, having purchase intention), needs of individual customers cannot always be fulfilled and the store clerk has a difficulty in inducing the customer to perform actual purchase behavior.

An exemplary object of the present disclosure is to provide a person who guides a customer, such as a store clerk, with information based on a movement history of a person who is guided, such as a customer.

### Solution to Problem

In an aspect, a customer service assistance method is provided. The customer service assistance method includes: acquiring, from a terminal device held by a store clerk, location information that indicates a location of the terminal device in a store; identifying a customer who is present in a predetermined range from the location in the store, using the location information and flow line information that indicates a movement history of the customer in the store; generating customer service information relating to the identified customer, using the flow line information; and outputting the generated customer service information to the terminal device.

In another aspect, an information processing device is provided. The information processing device includes: acquisition means for acquiring first information that indicates a location; identification means for, using the first information, identifying an object that is present in a predetermined range from the location; generation means for generating second information relating to the identified object, using third information that indicates a movement history of the object; and output means for outputting the generated second information.

In further aspect, a non-transitory recording medium is provided. The non-transitory recording medium records a program causing a computer to execute: acquisition processing of acquiring information that is information generated using a movement history of an object present in a predetermined range from a location of a terminal device or a user of the terminal device and relates to the object; and output processing of outputting the acquired information and the object in association with each other.

In further aspect, a terminal device is provided. The terminal device includes: acquisition means for acquiring information that is information generated using a movement history of an object present in a predetermined range from a location of the terminal device or a user of the terminal device and relates to the object; and output means for outputting the acquired information and the object in association with each other.

In further aspect, a non-transitory recording medium is provided. The non-transitory recording medium records a program causing a computer to execute: acquisition processing of acquiring first information that indicates a location; identification processing of, using the first information, identifying an object that is present in a predetermined range from the location; generation processing of generating second information relating to the identified object, using third information that indicates a movement history of the object; and output processing of outputting the generated second information.

In further aspect, an information processing method is provided. The information processing method includes: acquiring first information that indicates a location; using the first information, identifying an object that is present in a predetermined range from the location; generating second information relating to the identified object, using third information that indicates a movement history of the object; and outputting the generated second information.

In further aspect, an information output method is provided. The information output method includes: acquiring information that is information generated using a movement history of an object present in a predetermined range from a location of a terminal device or a user of the terminal device and relates to the object; and outputting the acquired information and the object in association with each other.

In an aspect, a customer service assistance method is provided. The customer service assistance method includes: acquiring, from a terminal device held by a store clerk, location information that indicates a location of the terminal device in a store; identifying a customer who is present in a predetermined range from the location in the store, using the location information and flow line information that indicates a movement history of the customer in the store; generating customer service information relating to the identified customer, using the flow line information; and outputting the generated customer service information to the terminal device.

### Advantageous Effects of Invention

The present disclosure enables a person who is a guide, such as a store clerk, to be provided with information based on a movement history of a person who is guided, such as a customer.

### BRIEF DESCRIPTION OF DRAWINGS

FIG. 1 is a block diagram illustrating an example of a configuration of a customer service assistance system;

FIG. 2 is a block diagram illustrating an example of a hardware configuration of a server device;

FIG. 3A is a schematic view illustrating an example of map information and layout information;

FIG. 3B is a schematic view illustrating another example of the map information and the layout information;

FIG. 4 is a block diagram illustrating an example of a hardware configuration of a terminal device;

FIG. 5 is a block diagram illustrating a functional configuration of a customer service assistance system;

FIG. 6 illustrates an example of a data structure of flow line information;

FIG. 7 illustrates another example of the data structure of the flow line information;

FIG. 8 is a sequence chart illustrating an example of operation of a server device and a recording device;

FIG. 9 is a sequence chart illustrating an example of operation of a server device and a terminal device;

FIG. 10A is a diagram illustrating a first example of an image based on customer service information;

FIG. 10B is a diagram illustrating a second example of the image based on the customer service information;

FIG. 11 is a diagram illustrating a third example of the image based on the customer service information;

FIG. 12 is a diagram illustrating a fourth example of the image based on the customer service information;

FIG. 13 is a block diagram illustrating an example of a configuration of an information processing device;

FIG. 14 is a flowchart illustrating an example of operation of a information processing device;

FIG. 15 is a block diagram illustrating an example of a configuration of a terminal device;

FIG. 16 is a flowchart illustrating an example of operation of a terminal device; and

FIG. 17 is a block diagram illustrating an example of a hardware configuration of a computer device.

### EXAMPLE EMBODIMENT

### 1.1: First Example Embodiment

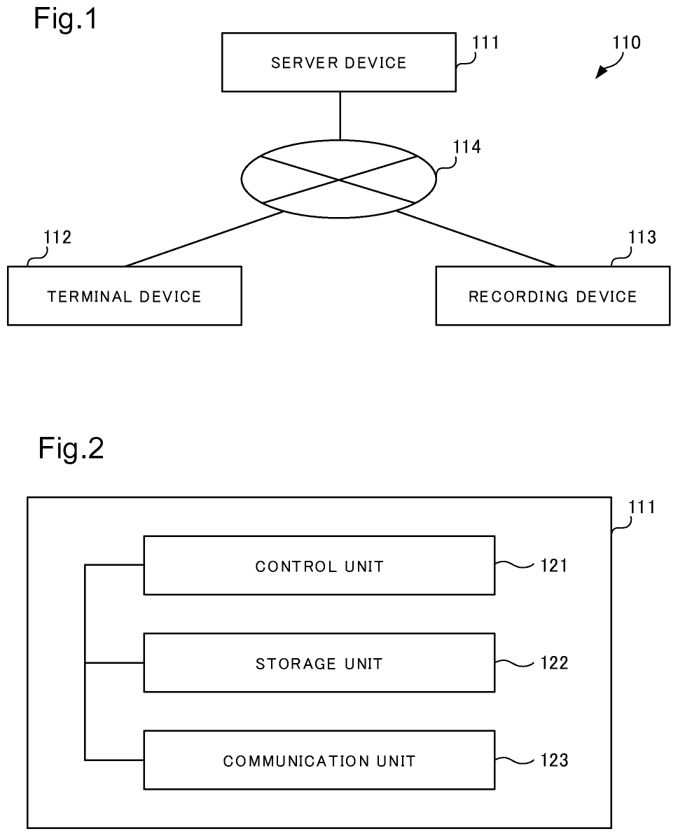

FIG. 1 is a block diagram illustrating a configuration of a customer service assistance system 110 according to an example embodiment. The customer service assistance system 110 is an information processing system for assisting customer service performed by a store clerk in a store. The customer service assistance system 110 includes at least one or more server devices 111, one or more terminal devices 112, and one or more recording devices 113. The server devices 111, the terminal devices 112, and the recording devices 113 may communicate with the other devices via a network 114, such as the Internet and a wireless local area network (LAN), or may directly communicate with the other devices, not via the network 114.

In the present example embodiment, a store refers to a space where products are sold or services are provided. The store referred to above may be a complex commercial facility, like a shopping mall, constituted by a plurality of retail stores. In addition, the store clerk, as used in the present example embodiment, refers to a person who sells products or provides services to customers in a store. The store clerk can also be said to be a person who guides customers in a store. In addition, the customer, as used in the present example embodiment, refers to a person who visits a store and receives sale of products or provision of services. The customer can also be said to be a person who is guided in a store by a store clerk. Note that it does not matter whether or not the customer, referred to above, has actually purchased products or services in the past or in the visit. In addition, the numbers of store clerks and customers are not limited specifically.

Each server device 111 supplies a terminal device 112 with information (hereinafter, also referred to as “customer service information”) for assisting customer service performed by a store clerk. The customer service referred to above may be rephrased as various types of guidance for customers. The server device 111 is a computer device, such as an application server, a mainframe, and a personal computer. However, the server device 111 is not limited to the computer devices exemplified above.

Each terminal device 112 presents information supplied by a server device 111. The presentation referred to above refers to outputting information in a perceptible manner. Although the perceptible output includes, for example, display by means of characters or an image, the perceptible output can include perception other than visual perception, such as auditory perception and tactile perception. In addition, the terminal device 112 is used by a store clerk. The terminal device 112 may be an electronic device held or worn by a store clerk. The terminal device 112 is a computer device, such as a smartphone, a tablet terminal, and a wearable device. However, the terminal device 112 is not limited to the computer devices exemplified above.

Each terminal device 112 and a store clerk are associated with each other by a predetermined method. For example, the association of each terminal device 112 with a store clerk may be determined in advance. Alternatively, each terminal device 112 may be associated with a specific store clerk by a well-known authentication method (password authentication, biometric authentication, and the like). In addition, a store clerk may hold an electronic device or a wireless tag separately from a terminal device 112, and the electronic device or wireless tag may be associated with the terminal device 112.

Each recording device 113 is an electronic device for measuring locations of persons (customers and store clerks). In the present example embodiment, the recording device 113 is an image capturing device, such as a monitoring camera, that is disposed on a ceiling or the like of a store and records images (that is, still images). In this case, the recording device 113 transmits image data representing captured images to a server device 111. The recording device 113 performs image capturing at a predetermined time interval and transmits image data in a repeated manner to the server device 111. Images represented by the image data may be either black-and-white images or color images and the resolution thereof is not limited specifically. The recording device 113 can also be said to transmit image data representing a video (that is, a moving image) constituted by still images captured at a predetermined time interval to the server device 111.

The total number of each of the server devices 111, the terminal devices 112, and the recording devices 113 is not limited specifically. For example, the same or fewer number of terminal devices 112 than the number of store clerks may be included in the customer service assistance system 110. In addition, while at least one server device 111 can cover a required load, the number of server devices 111 may be increased according to the number of terminal devices 112 or other factors. The number of recording devices 113 can be varied according to the area and internal structure of the store.

FIG. 2 is a block diagram illustrating a hardware configuration of each server device 111. The server device 111 includes a control unit 121, a storage unit 122, and a communication unit 123. The server device 111 may include other constituent components, such as an input device (keyboard or the like) and a display device.

The control unit 121 controls operation of the server device 111. The control unit 121 is, for example, configured including one or more processors and one or more memories. The control unit 121 can, by executing a predetermined program, achieve functions to be described later.

The storage unit 122 stores data. The storage unit 122 includes a storage device, such as a hard disk drive and a flash memory. The storage unit 122 may be configured including a reader or writer for a detachable recording medium, such as an optical disk. The storage unit 122 is capable of storing data that are referred to by the control unit 121. In the data stored in the storage unit 122, map information is included. The storage unit 122 may store a program executed by the control unit 121.

The map information represents an internal structure (in particular, places where customers move back and forth) of the store and is data defining a coordinate system for the store. For example, the map information indicates coordinates of respective locations in the store with a Cartesian coordinate system with the origin set at a predetermined location of the store. In addition, the map information may include layout information. The layout information is data defining an arrangement of objects in the store. The layout information indicates, for example, locations of walls and store shelves of the store. From a certain point of view, it can also be said that the layout information indicates existence of an obstacle that obstructs a store clerk from visually recognizing a customer.

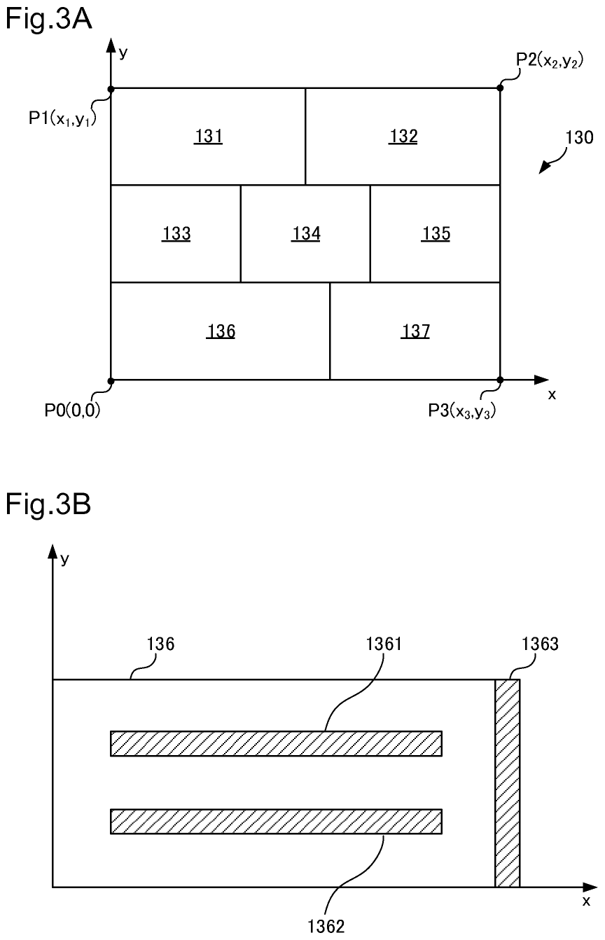

FIG. 3A is a schematic view illustrating an example of the map information and the layout information. Map information 130 defines a two-dimensional Cartesian coordinate system defined by the x-axis and the y-axis in the drawing for a store the floor of which has a rectangular shape. For example, the map information 130 represents a two-dimensional structure of a store by means of coordinate information indicating P0=(0, 0), P1=(x₁, y₁), P2=(x₂, y₂), and P3=(x₃, y₃) in the drawing. The layout information can represent a layout of sales spaces and store shelves in the store, using the x-axis and y-axis of the Cartesian coordinate system.

In the example in FIG. 3A, the floor of the store represented by the map information 130 is divided into areas 131, 132, 133, 134, 135, 136, and 137. The areas 131 to 137 represent sales spaces for different categories of products, such as the area 131 representing a sales space for foods and the area 132 representing a sales space for liquors. In this case, the layout information represents the areas 131 to 137, using the two-dimensional Cartesian coordinate system. The layout information may include coordinates of vertices or boundaries of the areas 131 to 137.

FIG. 3B is a schematic view illustrating another example of the layout information. In this example, store shelves 1361 and 1362 and a wall 1363 are included in the area 136. It is assumed that the store shelves 1361 and 1362 and the wall 1363 have height sufficiently higher than the height of the eye levels of store clerks. In this case, the wall 1363 separates the area 136 and the area 137 from each other. In this example, a store clerk cannot see the area 137 from the area 136. In this case, the layout information represents the store shelves 1361 and 1362 and the wall 1363, using the two-dimensional Cartesian coordinate system, as with the areas 131 to 137.

Note that the structure and layout of a store are not limited to the exemplification and may be more complex. In addition, the map information may be data representing a portion (not the whole) of a store. The layout information may be different data from the map information instead of a portion of the map information.

The communication unit 123 transmits and receives data with each terminal device 112 and each recording device 113. The communication unit 123 includes communication devices (or circuitry), such as a network adapter and an antenna. The communication unit 123 is wirelessly connected to each terminal device 112 and each recording device 113. The communication unit 123 may communicate with each terminal device 112 and each recording device 113 via another wireless equipment, such as an access point in a wireless LAN. The communication unit 123 may use different communication methods for communication with each terminal device 112 and communication with each recording device 113.

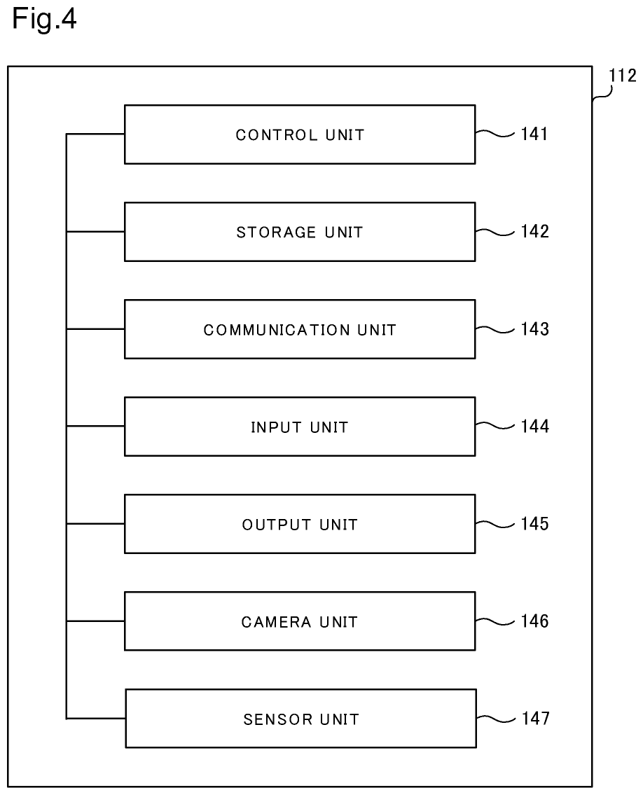

FIG. 4 is a block diagram illustrating a hardware configuration of each terminal device 112. The terminal device 112 includes a control unit 141, a storage unit 142, a communication unit 143, an input unit 144, and an output unit 145. In addition, the terminal unit 112 may include a camera unit 146 and a sensor unit 147. The terminal device 112 may also include another constituent component.

The control unit 141 controls operation of the terminal device 112. The control unit 141 is, for example, configured including one or more processors and one or more memories. The control unit 141 can, by executing a predetermined program, achieve functions to be described later.

The storage unit 142 stores data. The storage unit 142 includes a storage device, such as a flash memory. The storage unit 142 may be configured including a reader or writer for a detachable recording medium, such as a memory card. The storage unit 142 is capable of storing data that are referred to by the control unit 141. The storage unit 142 may store a program executed by the control unit 141.

The communication unit 143 transmits and receives data with each server device 111. The communication unit 143 includes an antenna, a radio frequency (RF) processing unit, a baseband processing unit, and the like. The communication unit 143 is wirelessly connected to each server device 111. The communication unit 143 may communicate with each server device 111 via another wireless equipment, such as an access point in the wireless LAN.

The input unit 144 accepts input from a user (a store clerk, in this case). The input unit 144 includes an input device, such as a key, a switch, and a mouse. In addition, the input unit 144 may include a touch screen display and/or a microphone for voice input. The input unit 144 supplies the control unit 141 with data according to the input from the user.

The output unit 145 outputs information. The output unit 145 includes a display device, such as a liquid crystal display. In the description below, although the terminal device 112 is assumed to include a touch screen display as the input unit 144 and the output unit 145, the terminal device 112 is not always limited to the configuration. In addition, the output unit 145 may include a speaker that outputs information by means of sound. The output unit 145 may include a light emitting diode (LED) or a vibrator for notifying the user of information.

The camera unit 146 captures an image of an object and thereby generates image data. The camera unit 146 includes an imaging device, such as a complementary metal oxide semiconductor (CMOS) image sensor. The camera unit 146 supplies the control unit 141 with the image data, which represent captured images. Images represented by the image data may be either black-and-white images or color images, and the resolution thereof is not limited specifically. In the description below, an image captured by the camera unit 146 is sometimes referred to as a “captured image” for the purpose of distinguishing the image from other images.

The sensor unit 147 measures a physical quantity that is usable for positioning of the terminal device 112. The sensor unit 147, for example, includes sensors for measuring acceleration, angular speed, magnetism, air pressure, and the like that are necessary for positioning by means of pedestrian dead-reckoning (PDR). Alternatively, the sensor unit 147 may include a so-called electronic compass, which measures azimuth, based on geomagnetism. In the present example embodiment, data (hereinafter, also referred to as “sensor data”) indicating a physical quantity measured by the sensor unit 147 can also be used for accuracy improvement or correction of the location of the terminal device 112.

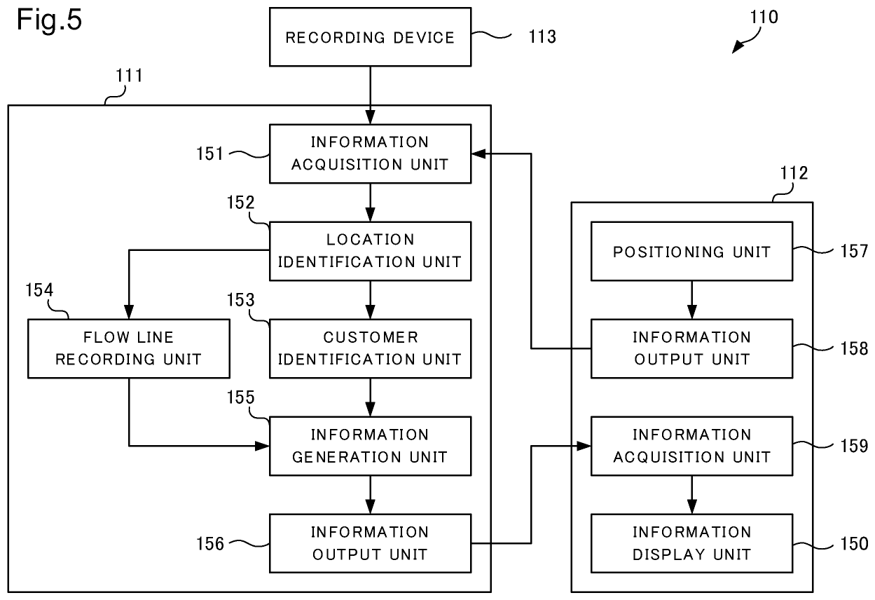

FIG. 5 is a block diagram illustrating a functional configuration of the customer service assistance system 110. Note that arrows between blocks in the block diagram exemplarily indicate flows of information. Therefore, flows of information in the customer service assistance system 110 are not limited to only the directions indicated by the illustrated arrows.

Each server device 111 includes an information acquisition unit 151, a location identification unit 152, a customer identification unit 153, a flow line recording unit 154, an information generation unit 155, and an information output unit 156. The server device 111 achieves the functions of these respective units by the control unit 121 executing programs. Each terminal device 112 includes a positioning unit 157, an information output unit 158, an information acquisition unit 159, and an information display unit 150. The terminal device 112 achieves the functions of these respective units by the control unit 141 executing programs.

The information acquisition unit 151 acquires information from each terminal device 112 and each recording device 113. More in detail, the information acquisition unit 151 acquires location information indicating a location of a terminal device 112 from the terminal device 112 and acquires image data from a recording device 113. In the present example embodiment, each terminal device 112 is held by a store clerk. Therefore, it can be said that the location of a terminal device 112 practically coincides with the location of a store clerk in this situation.

The location identification unit 152 identifies a location of a person. The location identification unit 152 at least identifies a location of a customer. The location identification unit 152 may identify not only a location of a customer but also a location of a store clerk. The location identification unit 152 identifies a location of a person in the store, based on image data acquired by the information acquisition unit 151.

For example, the location identification unit 152 may detect a moving object from images represented by the image data and recognize the detected object as a person. Alternatively, the location identification unit 152 may detect a region (the head, the face, the body, or the like) that has human-like features from the image and recognize that a person exists at the detected region. The location identification unit 152 is capable of, based on a location of a person who was recognized in this manner in the image and the map information, identifying a location of the person in the store.

The location identification unit 152 can recognize a person, using a well-known human body detection technology. For example, technologies that detect a human body or a portion (the face, a hand, or the like) of the human body included in images, using various types of image feature amounts and machine learning are generally known. Mapping of the location of a person identified by the location identification unit 152 onto the coordinate system of the map information can also be achieved using a well-known method. Note that, on the floor surface or the like of the store, points of reference (markers or the like) for associating the coordinate system of image data with the coordinate system of the map information may be disposed.

When identifying a location of a store clerk, the location identification unit 152 can improve accuracy of the location identification, based on location information transmitted from a terminal device 112. For example, the location identification unit 152 may correct a location having been identified based on the image data, based on the location information.

The customer identification unit 153 identifies a customer satisfying a predetermined condition, based on the location of a terminal device 112. In some cases, the customer identification unit 153 identifies a customer who is present in a predetermined range from the location of the terminal device 112. Although not limited specifically, the predetermined range referred to above is, for example, a range the boundary of which the store clerk holding the terminal device 112 can comparatively easily reach or visually recognize. Specifically, the predetermined range referred to above is within a radius of 5 m from the location of the terminal device 112. A parameter defining the predetermined range may have different values according to the area of the store and the number of store clerks or may be able to be set by the store clerk himself/herself.

The predetermined condition referred to above can also be said to be a locational condition, that is, a condition depending on the location of the terminal device 112 or a customer. Therefore, the condition may vary according to the map information or the layout information. For example, the customer identification unit 153 may exclude a range that the store clerk holding the terminal device 112 cannot see from the above-described predetermined range, based on the layout information. Specifically, when the location of the terminal device 112 is within a vicinity of a wall, the customer identification unit 153 may exclude the other side of the wall (that is, the farther side of the wall) from the predetermined range.

The customer identification unit 153 identifies a customer satisfying a predetermined condition, based on the location of a terminal device 112 identified based on location information transmitted from the terminal device 112 or identified by the location identification unit 152. For example, the customer identification unit 153, by comparing the location of the terminal device 112 with the location of a customer identified by the location identification unit 152, identifies a customer who is present within a predetermined range from the location of the terminal device 112.

The flow line recording unit 154 records a flow line of a person. As used herein, the flow line refers to a track of movement of a person. The flow line can also be said to be a movement history of a person. The movement history may be rephrased as a location history, a passage history, a walk history, a behavior history, or the like. The flow line recording unit 154 records transitions between locations of a person identified by the location identification unit 152. The flow line recording unit 154 records at least a flow line of a customer and may further record a flow line of a store clerk. In the description below, information indicating a flow line recorded by the flow line recording unit 154 is also referred to as “flow line information”. The flow line recording unit 154 records flow line information in the storage unit 122 and, in conjunction therewith, updates the flow line information every time the person is identified by the location identification unit 152.

Note that a location of a person at a time point indicated by the flow line information can be said to be identical to the location of the person identified at the time point by the location identification unit 152. In other words, a location of a person identified at a time point by the location identification unit 152 can be said to be equivalent to the latest location of the person recorded in the flow line information at the time point.

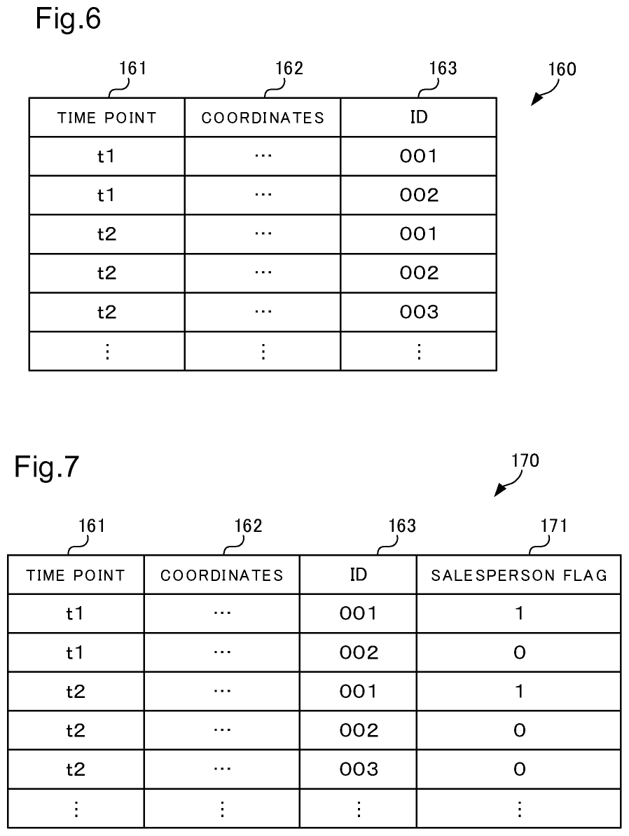

FIG. 6 illustrates an example of the data structure of the flow line information. In the example, flow line information 160 includes time points 161, coordinates 162, and identifiers (IDs) 163. Each time point 161 indicates a time point at which coordinates 162 are identified by the location identification unit 152. Each coordinates 162 indicate a location identified by the location identification unit 152. Each ID 163 is an identifier assigned to distinguish a flow line. Each ID 163 is, for example, a numerical value with a predetermined number of digits that is unique for each flow line.

The flow line recording unit 154 records flow line information at a time point t1 by assigning a unique ID to each of locations identified by the location identification unit 152 at the time point t1. Next, the flow line recording unit 154, at a time point t2 succeeding the time point t1, compares locations identified by the location identification unit 152 with the flow line information at the time point t1.

In general, speed at which a human walks is equal to or less than a certain speed (approximately 4 to 5 km per hour) and is not substantially faster than the speed. Therefore, it can be said that a range within which a person whose location was recorded in the flow line information at the time point t1 moves by the time point t2 is practically restricted to a certain range. When coordinates (first coordinates) identified at the time point t1 by the location identification unit 152 and coordinates (second coordinates) identified at the time point t2 thereby are within the certain range, the flow line recording unit 154 considers the coordinates to be a track of an identical person (hereinafter, this operation is also referred to as “identification”). When a person is identified at such coordinates at the time point t2, the flow line recording unit 154 assigns, to the second coordinates, an ID identical to the ID assigned to the first coordinates. The flow line recording unit 154 can successively update the flow line information by repeating the processing described above every time a person is identified by the location identification unit 152.

Note that, when a plurality of persons are in proximity to one another as in the case where the store is congested, there is a possibility that identification of a person by the above-described method cannot be done (or the identification is incorrectly done). In such a case, the flow line recording unit 154 may identify a person, using another method. For example, the flow line recording unit 154 may assign an ID to coordinates, based on the movement direction of a person represented by a flow line. Alternatively, the flow line recording unit 154 may assign an ID to coordinates, based on other features (color of the hair, the skin, or clothes, features of the face, the gender, and the like of a person) that can be obtained from the image data.

FIG. 7 illustrates another example of the data structure of the flow line information. In the example, flow line information 170 includes store clerk flags 171 in addition to time points 161, coordinates 162, and IDs 163, which are similar to those in the flow line information 160. Each store clerk flag 171 is a flag for distinguishing a flow line of a store clerk and a flow line of a customer from each other. Regarding the store clerk flags 171, for example, “1” and “0” are assigned to a flow line of a store clerk and a flow line of a customer, respectively.

The flow line recording unit 154 can discriminate between a store clerk and a customer, based on location information transmitted from a terminal device 112. For example, locations identified by the location identification unit 152 include a location of a store clerk and a location of a customer. On the other hand, the location that the location information indicates represents a location of a store clerk. Therefore, the flow line recording unit 154 can determine that, among the locations identified by the location identification unit 152, a location that coincides with a location indicated by the location information or locations the distance between which is equal to or less than a predetermined threshold value (that is, within an error range) is/are a location(s) of a store clerk. Alternatively, when the store clerks wear specific items (uniforms, name tags, and the like), the flow line recording unit 154 can discriminate between a store clerk and a customer by recognizing image features of such items from the image data.

Note that the flow line recording unit 154 does not have to discriminate between a store clerk and a customer at all time points at which flow line information is recorded. That is, the flow line recording unit 154 only has to discriminate between a store clerk and a customer at least any of time points at which flow line information is recorded with the same ID. For example, in the example in FIG. 7, when, to a flow line to which an ID “001” is assigned at a time point “t1”, a store clerk flag “1” is assigned, the flow line recording unit 154 may, at a time point “t2”, assign the store clerk flag “1” to a flow line to which the ID “001” is assigned without discriminating between a store clerk and a customer. Alternatively, the flow line recording unit 154 may discriminate whether a person is a store clerk or a customer at each time point and, referring to a result of the discrimination, assign an ID.

The information generation unit 155 generates customer service information. The customer service information is information for assisting customer service performed by a store clerk. The customer service information includes at least information relating to a customer identified by the customer identification unit 153. More in detail, the customer service information can include information that is included in flow line information or information that is identified based on the flow line information. The information generation unit 155, with respect to each terminal device 112 the location information of which was transmitted, generates customer service information including information relating to a customer present in a predetermined range from the device.

In the description below, a customer who is present in a predetermined range from a terminal device 112 is referred to as a “customer in the vicinity of the terminal device 112 (or a store clerk who holds the terminal device 112)”. That is, a range indicated by the “vicinity” referred to above is not always a fixed range and can vary according to a condition applied to identification of a customer by the customer identification unit 153.

The information generation unit 155 generates customer service information, using flow line information recorded by the flow line recording unit 154. For example, the information generation unit 155 generates customer service information indicating a movement history of a customer in the vicinity of a terminal device 112. In other words, the customer service information indicates what sales spaces (area) a customer present in the vicinity of the terminal device 112 has passed through, having reached the vicinity of the terminal device 112.

The information generation unit 155 may calculate dwell time in each area (sales space) of a customer present in the vicinity of a terminal device 112, based on flow line information. Alternatively, the information generation unit 155 may calculate speed (hereinafter, also referred to as “movement speed”) at which a customer present in the vicinity of a terminal device 112 moves, based on the flow line information and identify an area where the calculated movement speed fell lower than those in other areas. For example, the information generation unit 155 may identify an area where the movement speed of the customer fell lower than the average value with respect to the customer (or lower than a predetermined threshold value). An area where a customer stayed a long time or movement speed fell can be considered to be an area having a high possibility that the customer had an interest in the area. The information generation unit 155 may generate customer service information indicating dwell time calculated or an area identified in this manner.

The information generation unit 156 outputs customer service information generated by the information generation unit 155. More in detail, the information output unit 156 outputs customer service information to a terminal device 112. The customer service information output by the information output unit 156 is transmitted from the server device 111 to the terminal device 112 via the communication unit 123.

The positioning unit 157 measures a location of the terminal device 112. Any of well-known methods may be employed as a positioning method applied to the positioning unit 157. For example, when communication of the terminal device 112 is performed by means of a wireless LAN, the positioning unit 157 can measure a location of the terminal device 112, based on intensity of respective radio waves received from a plurality of access points. Such a positioning method is referred to as Wi-Fi (registered trademark) positioning or Wi-Fi positioning system (WPS). The positioning unit 157 supplies the information output unit 158 with location information indicating a measured location.

The information output unit 158 outputs location information supplied from the positioning unit 157. More in detail, the information output unit 158 outputs location information to the server device 111. The location information output by the information output unit 158 is transmitted from the terminal device 112 to the server device 111 via the communication unit 143.

The information acquisition unit 159 acquires customer service information transmitted from the server device 111. More in detail, the information acquisition unit 159 acquires customer service information output from the information output unit 156 via the communication unit 143.

The information display unit 150 performs display processing based on customer service information acquired by the information acquisition unit 159. The display processing referred to above indicates processing of making the output unit 145 display information. For example, as a result of the display processing by the information display unit 150, the output unit 145 displays an image in which a customer present in the vicinity of the terminal device 112 and customer service information relating to the customer are associated with each other. In addition, the output unit 145 may display an image in which a customer present in the vicinity of the terminal device 112 and customer service information relating to the customer are associated with each other in conjunction with a captured image captured by the camera unit 146.

The configuration of the customer service assistance system 110 is as described above. In the configuration as described above, the customer service assistance system 110, by generating and displaying customer service information, enables assistance in the customer service performed by a store clerk. Specifically, each server device 111, each terminal device 112, and each recording device 113 operate as described below.

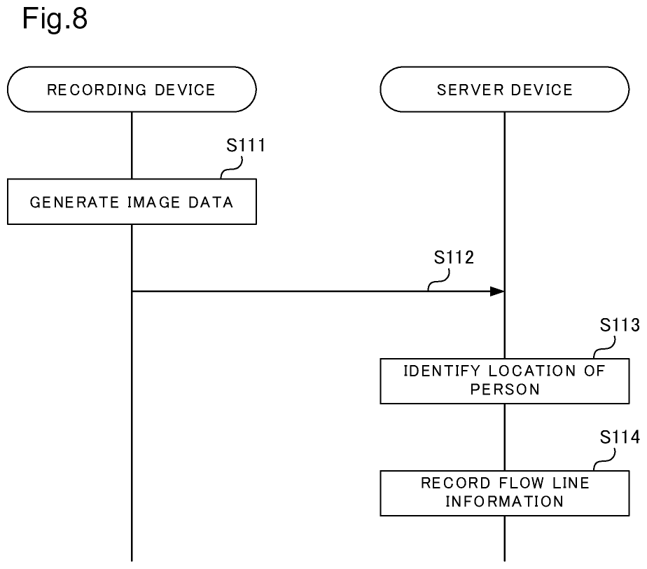

FIG. 8 is a sequence chart illustrating operation of a server device 111 and a recording device 113. In step S111, the recording device 113 generates image data representing a captured image. In step S112, the recording device 113 transmits the image data generated in step S111 to the server device 111. The server device 111 receives the image data transmitted by the recording device 113.

In step S113, the server device 111 identifies, based on the image data transmitted in step S112, a location of a person in the store. More in detail, the server device 111 identifies coordinates indicating a location of a person using a predetermined coordinate system. In step S114, the server device 111 records, based on the location identified in step S113, flow line information.

The server device 111, by repeating the processing in steps S113 and S114 based on image data supplied repeatedly, updates the flow line information. The flow line information, by being updated in this manner, represents transitions between locations of a person. That is, the flow line information represents how the location of a person has changed between a certain time point and the succeeding time point of the certain time point.

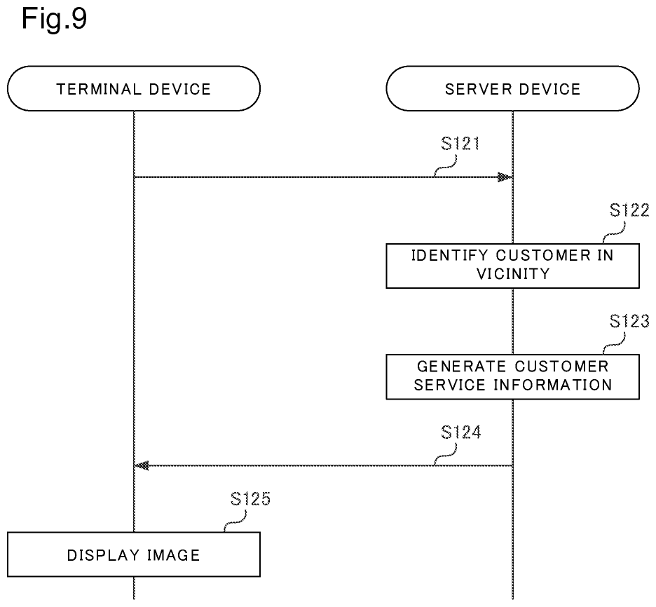

FIG. 9 is a sequence chart illustrating operation of a server device 111 and a terminal device 112. The server device 111 executes the following processing in parallel with the processing in FIG. 8. In step S121, the terminal device 112 transmits location information to the server device 111. The terminal device 112 may transmit, to the server device 111, location information at a predetermined time interval or at a timing at which the terminal device 112 receives a request (that is, an operation) from a store clerk. The server device 111 receives the location information transmitted by the terminal device 112.

In step S122, the server device 111 identifies a customer who is present in a predetermined range from a location indicated by the location information transmitted in step S121. That is, the server device 111 identifies a customer in the vicinity of the terminal device 112. The server device 111 identifies, based on the flow line information recorded by the processing in FIG. 8, a location of the customer.

In step S123, the server device 111 generates customer service information. The server device 111 generates the customer service information, using the flow line information of the customer identified in step S122. Note that, when a plurality of customers are identified in step S122, the server device 111 generates customer service information with respect to each customer.

In step S124, the server device 111 transmits the customer service information generated in step S123 to the terminal device 112. The terminal device 112 receives the customer service information transmitted by the server device 111. In step S125, the terminal device 112 displays an image based on the customer service information. A store clerk who is a user of the terminal device 112 can perform customer service activity (sales talk and the like) by referring to the image based on the customer service information.

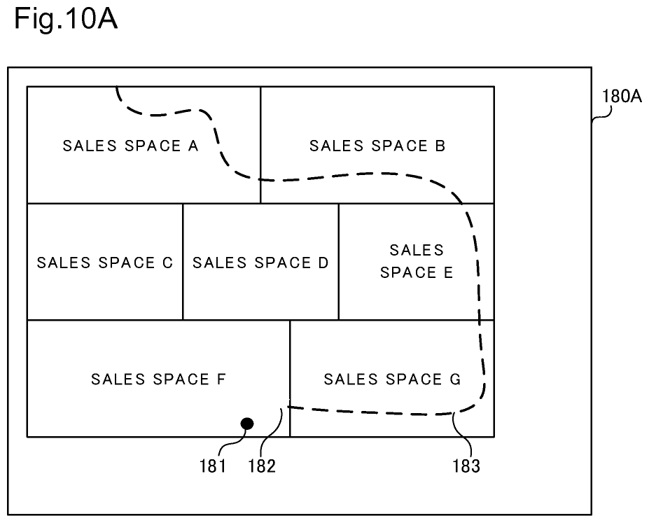

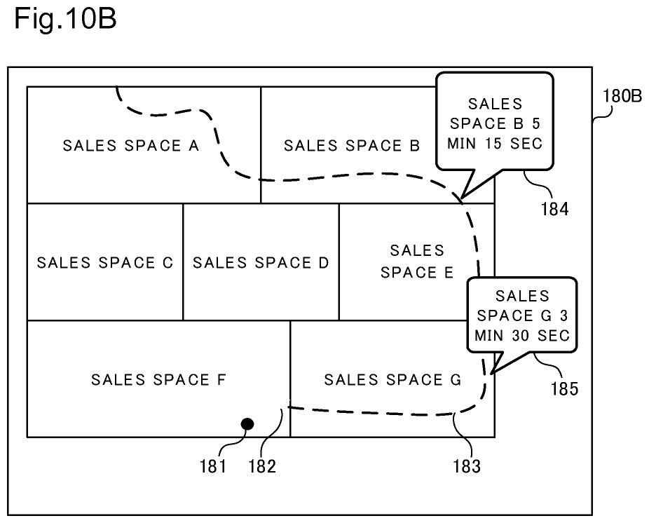

FIG. 10A is a diagram illustrating a first example of an image based on customer service information. In this example, an image 180A illustrates an image in which a mark 181 indicating a location of a store clerk, a mark 182 indicating a location of a customer who is present in the vicinity of the store clerk, and a flow line 183 of the customer are superimposed on a floor map of a store. The flow line 183 is equivalent to an example of display of customer service information. According to the first example, the store clerk is able to get to know what areas the customer present in the vicinity of the store clerk has passed through.

FIG. 10B is a diagram illustrating a second example of an image based on customer service information. In this example, an image 180B includes, in addition to the marks 181 and 182 and the flow line 183, balloons 184 and 185. The balloon 184 displays information relating to a specific area among the areas that the customer indicated by the mark 182 has passed through. The balloon 184 is equivalent to an example of display of customer service information.

For example, the balloon 184 displays an area where the customer stayed a long time or the movement speed fell, that is, an area having a high possibility that the customer had an interest in the area. Alternatively, the balloons 184 and 185 may display dwell time of the customer in such specific areas. According to the second example, the store clerk is able to get to know information that the store clerk cannot get to know only from the flow line 183, such as an area where dwell time of the customer was long and an area where the customer stopped or picked up and examined products.

Note that the information display unit 150 may determine a display mode, that is, an external appearance, of the balloons 184 and 185, based on customer service information. For example, the information display unit 150 may determine size or color of the balloons 184 and 185, based on at least either dwell time or movement speed. In the example in FIG. 10B, since dwell time at a “sales space B” is longer than dwell time at a “sales space G”, the information display unit 150 sets the size of the balloon 184 larger than that of the balloon 185. When configured in such a manner, the store clerk is able to intuitively understand the customer service information.

The terminal device 112 may display, as an image based on the customer service information, either the first example or the second example. Alternatively, the terminal device 112 may, after displaying the image 180A, make the screen transition to displaying of the image 180B in accordance with a predetermined operation (for example, an operation of tapping the mark 182 or the flow line 183) by the store clerk. Note that the first and second examples are also applicable to a case where a plurality of customers are present in the vicinity of a store clerk.

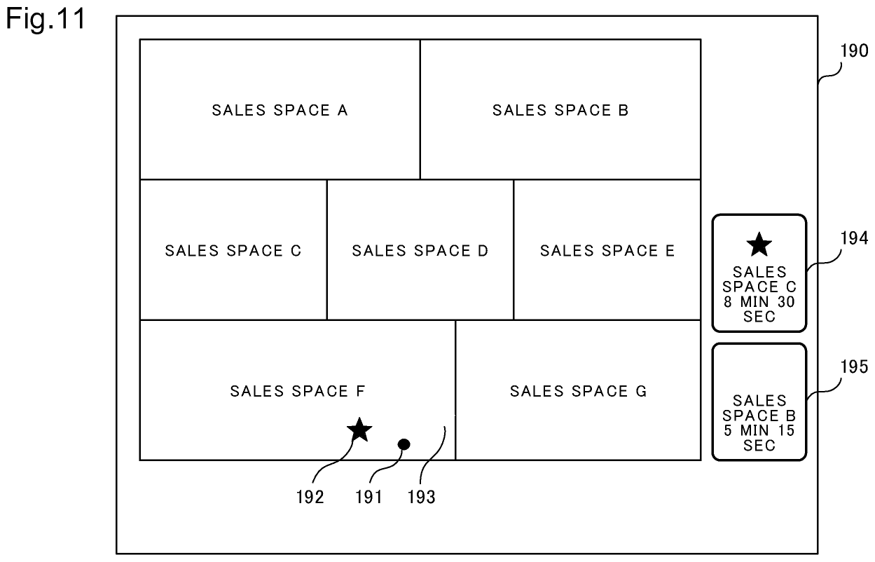

FIG. 11 is a diagram illustrating a third example of an image based on customer service information. In this example, an image 190 illustrates an image in which a mark 191 indicating a location of a store clerk and marks 192 and 193 indicating locations of two customers who are present in the vicinity of the store clerk are displayed in a superimposed manner onto the floor map of the store and, in conjunction therewith, additional information 194 and 195 relating to the customers are displayed. The additional information 194 and 195 are equivalent to examples of customer service information.

In this example, the additional information 194 indicates that an area where dwell time of a customer who is present at the location of the mark 192 was long is the “sales space C”. The additional information 195 indicates that an area where dwell time of a customer who is present at the location of the mark 193 was long is the “sales space B”.

The mark 192 and the additional information 194 are visually associated with each other. For example, in the additional information 194, the same mark as the mark 192 is included. In this case, the mark 193 and the additional information 195 also have a similar association. Alternatively, the marks 192 and 193 may be associated with the additional information 194 and 195, respectively, by color in such a way that the mark 192 and the additional information 194 are displayed in red and the mark 193 and the additional information 195 are displayed in blue.

According to the third example, the customer service information can be displayed separately from the floor map. This display mode enables a store clerk to recognize customer service information without being obstructed from visually recognizing a floor map. In addition, the store clerk can easily recognize associations between the mark 192 and the additional information 194 and between the mark 193 and the additional information 195 even when the marks 192 and 193 and the additional information 194 and 195 are not displayed in proximity to each other, respectively.

As described above, the customer service assistance system 110 according to the present example embodiment is capable of, by providing a store clerk with service based on the location information of customers (location-based service), assisting the customer service activity of a store clerk. More in detail, the customer service assistance system 110 is capable of supplying each terminal device 112 with customer service information based on the flow line information of a customer who is present in the vicinity of the terminal device 112. This capability causes a store clerk holding the terminal device 112 to be provided with information based on a movement history of the customer.

In general, it is difficult for a store clerk to know, before beginning customer service, a purpose of a visit to the store by a customer who is present in front of the store clerk. In addition, it is also generally difficult for a store clerk to know taste of a customer who is present in front of the store clerk. On the other hand, the customer service assistance system 110 enables a store clerk to obtain information based on a movement history of a customer who is present in the vicinity of the store clerk via the terminal device 112. The customer service activity based on such information can be said to have a higher possibility of satisfying needs of individual customers than customer service activity based on statistical information. In addition, the customer service activity based on such information can provide a determination criterion with objectivity compared with customer service activity only based on experience and intuition of a store clerk.

Therefore, a store clerk is able to, by using the customer service assistance system 110, perform more effective customer service activity (that is, activity to induce the customer to perform purchase behavior and raise the customer satisfaction level) to a customer who is present in front of the store clerk than in a case where such a system is not used. For example, the store clerk is able to recommend, to a customer who is present in front of the store clerk, a product in which the customer highly probably has an interest. In addition, when a plurality of customers are present in front of the store clerk, the store clerk is able to speak to each customer in a different viewpoint in accordance with the movement history of the customer.

As an example, it is assumed that, in a sales space for TVs (television receivers) in an electrical appliance store, a customer is present in the vicinity of a store clerk. TVs on the market can, in general, have different features depending on manufacturers and models. For example, TVs have different features such that, while a certain type of TV has a distinctive feature in picture quality, another type of TV has a distinctive feature in sound quality. In such a case, when a customer stayed a long time in the sales space for optical devices, such as cameras, before having come to the sales space for TVs, a conjecture that the customer is more interested in picture quality than in other features can hold true. Therefore, in this case, the store clerk has a higher possibility of satisfying needs of the customer when recommending a TV having a distinctive feature in picture quality than when recommending TVs having other features. On the other hand, when the customer stayed a long time in the sales space for audio products before having come to the sales space for TVs, the store clerk has a higher possibility of satisfying needs of the customer when recommending a TV having a distinctive feature in sound quality.

### 1.2: Variations of First Example Embodiment

To the customer service assistance system 110 according to the present example embodiment, the following variations are applicable. These variations may be applied in combination as needed basis. In addition, these variations may be applied to not only the present example embodiment but also other example embodiments to be described later.

(1) The customer identification unit 153 is capable of identifying a customer who is present in the vicinity of a store clerk, based on the location of a terminal device 112. In this case, the customer identification unit 153 may determine whether or not a preset number of (for example, one) or more customers are present in a predetermined range (for example, a range having a radius of 3 m) from the store clerk. When a preset number of or more customers are not present in the predetermined range from the store clerk, the customer identification unit 153 may expand the extent of a vicinity referred to above, such as from “a radius of 3 m” to “a radius of 5 m”. That is, in the example, the specific extent of a “vicinity” is variable.

Alternatively, the customer identification unit 153 may identify only one customer the distance of which to the store clerk is the shortest. In this case, the customer information may include information relating to the one customer and does not have to include information relating to other customers.

(2) The customer identification unit 153 may identify a customer who is present in the vicinity of a terminal device 112, based on the location and the facing direction of the terminal device 112. In this case, the information acquisition unit 151 acquires location information indicating a location of the terminal device 112 and information indicating a facing direction of the terminal device 112. The information indicating the facing direction of the terminal device 112 is, for example, sensor data output by the sensor unit 147.

Note that, in the following description, for the purpose of description, it is assumed that the facing direction of a terminal device 112 and the facing direction of a store clerk are in a certain relationship. For example, when the terminal device 112 is a smartphone, the store clerk faces the front surface (the surface including a display) of the terminal device 112. In this case, the direction of the front face for the store clerk substantially coincides with the direction of the back face of the terminal device 112. Therefore, in this case, the customer identification unit 153 considers that the direction of the back face of the terminal device 112 is equivalent to the direction of the front face for the store clerk.

The customer identification unit 153 may determine the range of a vicinity referred to above, based on the facing direction of the terminal device 112. For example, there is a high possibility that a store clerk does not become aware of a customer who is present behind the store clerk. Thus, the customer identification unit 153 may limit the range of a vicinity referred to above to the front of the store clerk. For example, the customer identification unit 153 may limit the range of a vicinity referred to above to a half (that is, a semicircle) on the front side of a circle with a radius of 3 m centered around the location of the terminal device 112.

Note that the facing direction of a store clerk may be identified based on image data supplied from the recording device 113. In this case, the location identification unit 152 identifies a location of a store clerk and, in conjunction therewith, identifies a facing direction of the store clerk. The facing direction of a store clerk in this case may be the direction of the face of the store clerk or the direction of the line of sight of the store clerk. The location identification unit 152 can identify a facing direction of a store clerk, using a well-known face detection technology or sight line detection technology.

(3) When flow line information of customers and flow line information of store clerks are included in the flow line information, the customer identification unit 153 may identify a customer in the vicinity of a store clerk holding a terminal device 112 by excluding a customer whose locational relationship with a store clerk (hereinafter, also referred to as “another store clerk”) different from the store clerk satisfies a predetermined condition. The predetermined condition referred to above is, for example, a condition requiring the distance between the another store clerk and the customer to be equal to or less than a threshold value or a condition requiring the distance between the another store clerk and the customer to be less (that is, nearer) than the distance between the store clerk holding the terminal device 112 and the customer.

When such a condition is satisfied, it can be said that another store clerk is present near the customer. Therefore, it can be said that the customer has a high possibility of being served by the another store clerk or being able to comparatively easily speak to the another store clerk. The customer identification unit 153 may exclude such a customer from targets of customer service and identify a customer near whom another store clerk is not present.

(4) The positioning unit 157 may measure a location of a terminal device 112, using another positioning system for indoor or outdoor use. For example, the positioning unit 157 may use a global navigation satellite system (GNSS), such as a global positioning system (GPS). In addition, as a positioning system for indoor use, an indoor messaging system (IMES), a positioning system using Bluetooth (registered trademark), a positioning system using geomagnetism, and the like are known. Moreover, the positioning unit 157 may measure a location, using sensor data output by the sensor unit 127. The positioning unit 157 may measure a location, using a plurality of positioning systems in combination. For example, the positioning unit 157 may perform positioning using the Wi-Fi positioning and the PDR in combination.

(5) Each terminal device 112 does not have to include the positioning unit 157. In this case, the information output unit 158 is configured to output, in place of location information, information required for positioning of the terminal device 112. The information required for positioning of the terminal device 112 is, in the case of, for example, the Wi-Fi positioning, information indicating intensity of respective radio waves received from a plurality of access points. Alternatively, the information required for positioning of the terminal device 112 can include sensor data output from the sensor unit 127.

In this variation, the server device 111 identifies a location of each terminal device 112, based on the information required for positioning of the terminal device 112. That is, in this case, it can also be said that the server device 111 has a function (function of identifying a location of the terminal device 112) equivalent to the positioning unit 157.

Alternatively, the information required for positioning of the terminal device 112 may be transmitted to a positioning device different from both the server device 111 and the terminal device 112. The positioning device identifies a location of the terminal device 112, based on the information required for positioning of the terminal device 112 and transmits location information representing the identified location to the server device 111. In this case, the server device 111 does not have to include a function equivalent to the positioning unit 157 and is only required to receive location information from the positioning device.

(6) The information display unit 150 may display customer service information relating to a customer present in the vicinity of a terminal device 112 in conjunction with an image captured by the camera unit 146 (that is, a captured image). For example, when a customer is recognized from the captured image, the information display unit 150 may display customer service information relating to the customer by superimposing the customer service information onto the image.

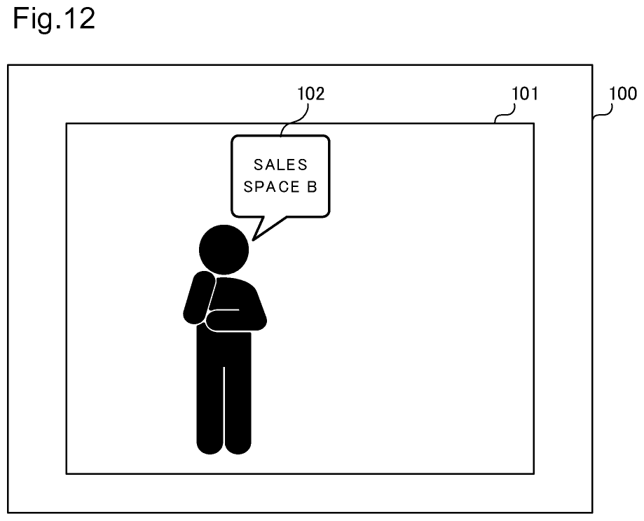

FIG. 12 is a diagram illustrating a fourth example of an image based on customer service information. In this example, an image 100 includes a captured image 101 and a balloon 102. The captured image 101 is an image captured by the camera unit 146 and includes a customer in the captured range thereof. The balloon 102, in this example, displays an area where the customer stayed a long time. The balloon 102 is, as with the balloon 184 in FIG. 10B, equivalent to an example of display of customer service information. That is, this example is an example in which, when a store clerk, directing the camera unit 146 of the terminal device 112 toward the customer, captures an image of the customer, customer service information is displayed in a superimposed manner onto the captured image.

For example, the information display unit 150 is capable of displaying the image 100, using a human body detection technology and an augmented reality (AR) technology. Specifically, the information display unit 150 detects a region that includes human-like features from the captured image. The detection may be performed in a similar manner to the detection of a person by the location identification unit 152. Next, the information display unit 150 identifies a location, that is, coordinates in the store, of the person detected from the captured image. The information display unit 150 may, for example, identify a location of the person, based on sensor data output from the sensor unit 127 and location information output from the positioning unit 157.

When the location of the person is identified from the captured image, the information display unit 150 compares the identified location with a location indicated by customer service information. When these locations coincide with each other or the distance between these locations is equal to or less than a predetermined threshold value (that is, within a range of error), the information display unit 150 associate the identified person with the customer service information. The information display unit 150 displays the balloon 102 corresponding to the customer service information associated in this manner in association with the customer in the captured image (for example, in a vicinity of the customer).

(7) Flow line information may include, in addition to the information exemplified in FIGS. 6 and 7, any other information that can be associated with a movement history. For example, flow line information may include attribute information indicating an attribute of a person and behavior information indicating behavior of a person. The attribute information and the behavior information may be included only in the flow line information of a customer or included in both the flow line information of a customer and the flow line information of a store clerk.

The attribute information, for example, indicates characteristics of a person recognizable from an image captured by a recording device 113. Specifically, the attribute information may indicate the gender of a person, an age group (child, adult, and the like), the color of clothes, and the like. In addition, the store clerk flags 171 in FIG. 7 can be said to be information indicating which group among a plurality of groups, that is, “store clerks” and “customers”, a person belongs to. Therefore, the store clerk flags 171 can be said to be equivalent to an example of the attribute information.

The behavior information, for example, indicates a gesture or behavior in front of shelves of a person. The behavior in front of shelves described above means characteristic behavior performed by a customer around store shelves. The behavior in front of shelves includes an action of picking up a product from a store shelf, an action of stopping in front of a store shelf, an action of going back and forth in front of a store shelf, and the like. In addition, the gestures can include a gesture unique to either store clerks or customers. For example, a motion of bowing can be said to be a gesture unique to store clerks. The behavior information is, for example, recognizable from an image captured by a recording device 113.

By referring to customer service information including attribute information, a store clerk is able to, when, for example, a plurality of customers are present in the vicinity of the store clerk, more easily determine a correspondence relationship between each customer and customer service information. In addition, by referring to customer service information including behavior information, the store clerk is able to perform customer service activity tailored to each customer. For example, by knowing a product that a customer picked up and an area where the customer stopped, the store clerk is able to obtain a clue to know interests and concerns of the customer.

(8) The image data corresponding to the image exemplified in FIG. 10A, 10B, or 11 may be generated by either the server device 111 or the terminal device 112. That is, customer service information transmitted from the server device 111 may include coordinate information indicating a location of a customer and dwell time of the customer or include image data representing an image to be displayed on the terminal device 112. In addition, when generating such image data, the terminal device 112 may store map information in the storage unit 122 in advance or receive map information from the server device 111.

(9) Each recording device 113 can be replaced with another device (hereinafter, also referred to as “another positioning device”) capable of measuring a location of a person. For example, when a customer holds a transmitter that transmits a predetermined signal (a beacon or the like), the another positioning device referred to above may be a receiver that receives the signal. Alternatively, the another positioning device may be an optical sensor that measures a location of a person by means of a laser beam or an infrared ray and may include a so-called distance image sensor. In addition, the another positioning device may include a pressure sensor that detects change in pressure (that is, weight) on the floor surface of the store and may measure a location of a person, based on output from the pressure sensor. Further, the another positioning device may measure a location of a person by combining a plurality of positioning methods.

(10) The output unit 145 may notify a store clerk of presence of a customer in the vicinity of his/her terminal device 112 by a method other than display. For example, the output unit 145 may output an alarm sound when a customer is present in the vicinity of the terminal device 112. In addition, the output unit 145 may vibrate a vibrator when a customer is present in the vicinity of the terminal device 112.

(11) Location information may be transmitted from, in place of a terminal device 112, an electronic device or a wireless tag that is held by a store clerk and is associated with the terminal device 112. When a terminal device 112 is held by a store clerk, such location information can be said to indicate a location of the terminal device 112 and a location of the store clerk holding the terminal device 112.

(12) The data structures of map information and flow line information are not limited to the exemplified structures. The map information and the flow line information may have well-known or other similar data structures. In addition, areas in the map information may be defined based on the arrangement of store fixtures, such as store shelves and display counters, or based on the arrangement of products themselves.

(13) Each server device 111 may transmit guidance information to, in place of a terminal device 112, another specific device. The specific device referred to above is used by a person (hereinafter, also referred to as a “director”) who remotely directs a store clerk performing customer service. In this case, the director, referring to an image based on the guidance information, directs a store clerk in the store, using wireless equipment, such as a transceiver.

### 2: Second Example Embodiment

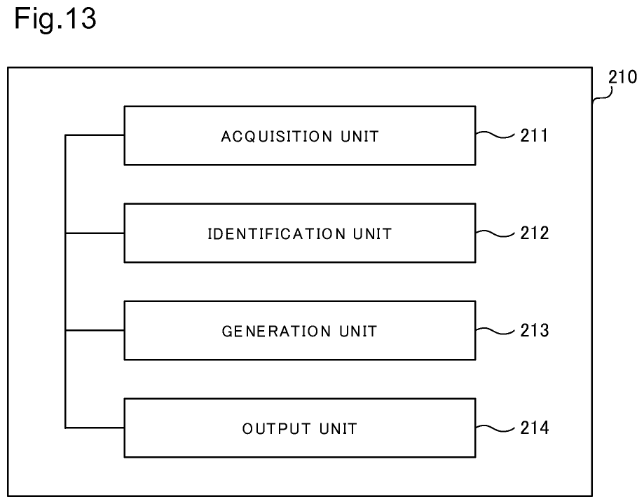

FIG. 13 is a block diagram illustrating a configuration of an information processing device 210 according to another example embodiment. The information processing device 210 is a computer device for assisting customer service performed by a store clerk in a store. The information processing device 210 can be said to be a server device in a client-server model. The information processing device 210 includes an acquisition unit 211, an identification unit 212, a generation unit 213, and an output unit 214.

Note that, among the terms to be used in the following example embodiments and variations, terms that were also used in the first example embodiment are, unless otherwise stated, used in the same meanings as the terms used in the first example embodiment.

The acquisition unit 211 acquires information indicating a location (hereinafter, also referred to as “first information”). The first information indicates, for example, a location of a terminal device. In the example embodiment, the first information indicates a location of a terminal device explicitly or implicitly. In other words, the first information may be information representing the location itself of a terminal device (that is, indicating the location explicitly) or may be information from which the location of the terminal device is, as a result of predetermined operation and processing, identified (that is, indicating the location implicitly). For example, the “location information” or “information required for positioning of a terminal device 112” in the first example embodiment can be equivalent to an example of the first information. The first information is not limited to the location information as long as a location can be identified therefrom using any method. Thus, the first information may be rephrased as information for identifying a location, information from which a location can be identified, and the like.

Note that the first information may be information indicating a location of a user of a terminal device. For example, when the location of a user of a terminal device is identified by image analysis, image data can be equivalent to the first information. In this case, the image data can be said to implicitly indicate the location of the user of the terminal device. The acquisition unit 211 may acquire a plurality of types of first information like location information and image data.

The identification unit 212 identifies an object that is present in a predetermined range from a location indicated by first information acquired by the acquisition unit 211, using the first information. The identification method of an object by the identification unit 212 is not limited specifically. For example, the identification unit 212 may identify an object, based on image data or may identify an object, based on other information.

In the present example embodiment, the object refers to a person (for example, a customer) whom a user (for example, a store clerk) of a terminal device approaches or an object traveling with the person. For example, in a store, some customers shop, pushing a shopping cart. In such a case, the identification unit 212 may, instead of identifying the customer himself/herself, identify a shopping cart that the customer is pushing. In this case, a transmitter transmitting a beacon may be attached to the shopping cart, or a marker that differs for each shopping cart may be pasted to the shopping cart. Alternatively, the object referred to above may be specific equipment or a specific article that is held by a customer and can be discriminated individually.

In addition, the object referred to above may be classified into a plurality of groups. For example, the first example embodiment is an example in which the object referred to above is set as a person. In the first example embodiment, persons can be classified into “store clerks” and “customers”.

When objects are classified into a plurality of groups, the identification unit 212 may identify an object that is present in a predetermined range from a location indicated by first information acquired by the acquisition unit 211 and belongs to a specific group among the plurality of groups. For example, when, as in the first example embodiment, objects are classified into “store clerks” and “customers”, the identification unit 212 is capable of selectively identifying only a customer out of objects (persons) that are present in a predetermined range from a location indicated by first information acquired by the acquisition unit 211.

The generation unit 213 generates information (hereinafter, also referred to as “second information”) relating to an object identified by the identification unit 212. The second information is, for example, customer service information in the first example embodiment. The generation unit 213 generates second information, using information (hereinafter, also referred to as “third information”) indicating a movement history of an object identified by the identification unit 212. The third information may include information indicating transitions between locations of a plurality of objects. The third information is, for example, flow line information in the first example embodiment.

The second information may include information indicating, among a plurality of areas, an area where an object identified by the identification unit 212 had been present for a predetermined time or longer or the movement speed of the object fell. In addition, the second information may include information (for example, dwell time) indicating a period of time during which an object identified by the identification unit 212 had been present in an area.

The third information may be used for, in addition to generation of second information by the generation unit 213, identification of a location by the identification unit 212. The third information can also be said to indicate transitions between locations of an object during a period from a time point in the past to the latest time point (hereinafter, for descriptive purposes, also referred to as “the present”). The generation unit 213 generates second information particularly based on past locations among the third information. On the other hand, the identification unit 212 is capable of identifying a location of an object present in a predetermined range from a location of a terminal device particularly based on the present (latest) location among the third information.

The output unit 214 outputs second information generated by the generation unit 213. The output unit 214 outputs second information to a terminal device the location of which is indicated by first information. The second information may be directly supplied from the information processing device 210 to a terminal device or may be supplied to the terminal device via (that is, relayed by) another device.

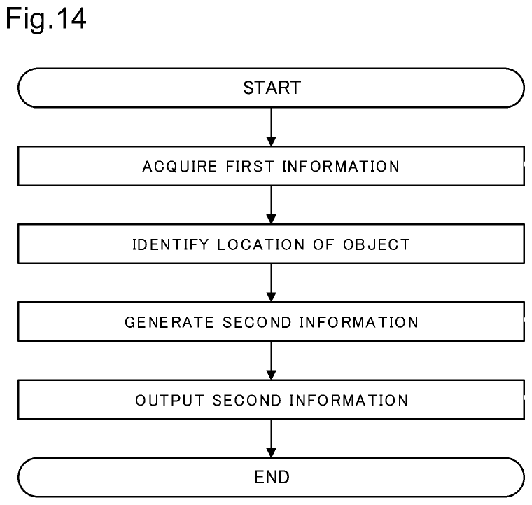

FIG. 14 is a flowchart illustrating operation of the information processing device 210. In step S211, the acquisition unit 211 acquires first information. In step S212, the identification unit 212 identifies an object that is present in a predetermined range from a location indicated by the first information acquired in step S211. In step S213, the generation unit 213 generates second information relating to the object identified in step S212, using third information. In step S214, the output unit 214 outputs the second information generated in step S213.

With the information processing device 210 according to the present example embodiment, second information relating to an object present in a predetermined range from a location indicated by first information is generated based on a movement history of the object. Therefore, the information processing device 210 can produce similar operational effects to those of the customer service assistance system 110 of the first example embodiment.

Note that the information processing device 210 corresponds to the server device 111 of the first example embodiment. Specifically, the acquisition unit 211 corresponds to the information acquisition unit 151. The identification unit 212 corresponds to the customer identification unit 153. The generation unit 213 corresponds to the information generation unit 155. The output unit 214 corresponds to the information output unit 156. In addition, the information processing device 210 may be configured to include components equivalent to the location identification unit 152 and the flow line recording unit 154 of the server device 111.

Note that the acquisition unit 211 may acquire, as fourth information, information indicating a direction of a terminal device or a user of the terminal device. In this case, the identification unit 212 identifies an object, based on a location indicated by the first information and a direction indicated by the fourth information. For example, sensor data in the first example embodiment can be equivalent to an example of the fourth information.

### 3: Third Example Embodiment

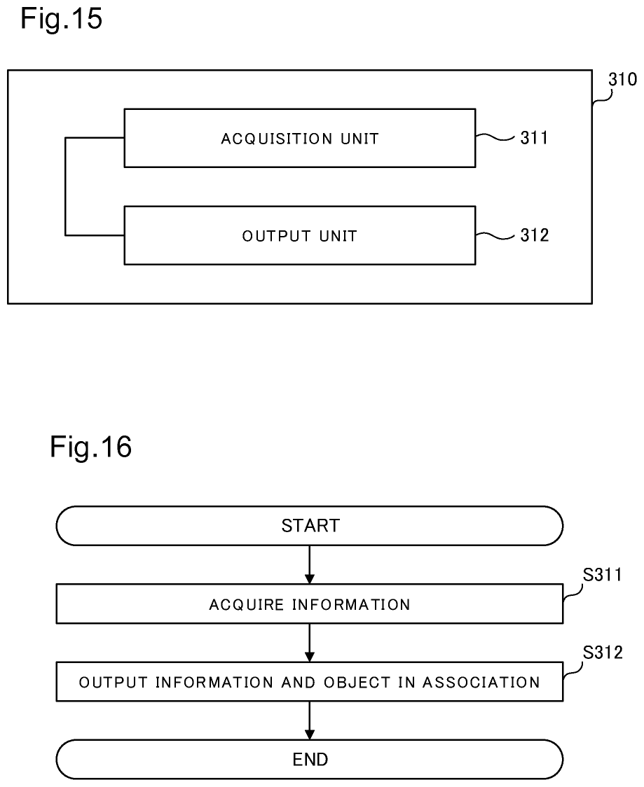

FIG. 15 is a block diagram illustrating a configuration of a terminal device 310 according to still another example embodiment. The terminal device 310 is a computer device for assisting customer service performed by a store clerk in a store. For example, the terminal device 112 in the first example embodiment is equivalent to an example of the terminal device 310. The terminal device 310 may be used in such a manner as to, collaborating with the information processing device 210 of the second example embodiment, transmit and receive data to and from each other. The terminal device 310 can be said to be a client device in a client-server model. The terminal device 310 includes at least an acquisition unit 311 and an output unit 312.

The acquisition unit 311 acquires information relating to an object that is present in a predetermined range from a location of the terminal device 310 or a user thereof. This information corresponds to second information in the second example embodiment and is generated based on, for example, a movement history of the object, which is present in the predetermined range from the location of the terminal device 310 or the user thereof.

The output unit 312 outputs information acquired by the acquisition unit 311 and an object that is present in a predetermined range from a location of the terminal device 310 or a user thereof in association with each other. In some cases, the output unit 312 displays the information, acquired by the acquisition unit 311, in conjunction with the object. Note, however, that the output referred to above can, as with the first example embodiment, include perceptible output other than display. An association between information acquired by the acquisition unit 311 and an object may, for example, be described in the information. The output unit 312 may identify an association between information and an object, based on the information or by another method.

Note that the output unit 312 may output information indicating the location of the terminal device 310 or a user thereof. This information corresponds to first information in the second example embodiment and indicates the location of the terminal device 310 or the user thereof explicitly or implicitly. In this case, the output unit 312 outputs information (first information) to a device (for example, the information processing device 210) generating second information. In addition, the acquisition unit 311 acquires information (second information) relating to an object that is present in a predetermined range from a location indicated by the information (first information) output by the output unit 312.

FIG. 16 is a flowchart illustrating operation of the terminal device 310. In step S311, the acquisition unit 311 acquires information relating to an object that is present in a predetermined range from a location of the terminal device 310 or a user thereof. In step S312, the output unit 312 outputs the information acquired in step S311 and the object in association with each other. For example, the output unit 312 may display the information acquired in step S311 in conjunction with an image captured including the object.

The terminal device 310 according to the present example embodiment enables information relating to an object that is present in a predetermined range from a location of the device or a user thereof and the object to be output in association with each other. Therefore, the terminal device 310 can produce similar operational effects to those of the customer service assistance system 110 of the first example embodiment.

Note that the terminal device 310 corresponds to a terminal device 112 of the first example embodiment. Specifically, the acquisition unit 311 corresponds to the information acquisition unit 159. The output unit 312 corresponds to the information display unit 150 or the information output unit 158. In addition, the terminal device 310 may be configured to further include components equivalent to the positioning unit 157 of the terminal device 112.

### 4: Variations

To the above-described first to third example embodiments, for example, variations as described below can be applied. These variations may be appropriately combined as needed basis.

(1) Specific hardware configurations of the devices according to the present disclosure (the server device 111, the terminal device 112, the information processing device 210, and the terminal device 310) include various variations and are not limited to a specific configuration. For example, the devices according to the present disclosure may be achieved using software or may be configured in such a way that various types of processing are divided among a plurality of pieces of hardware.

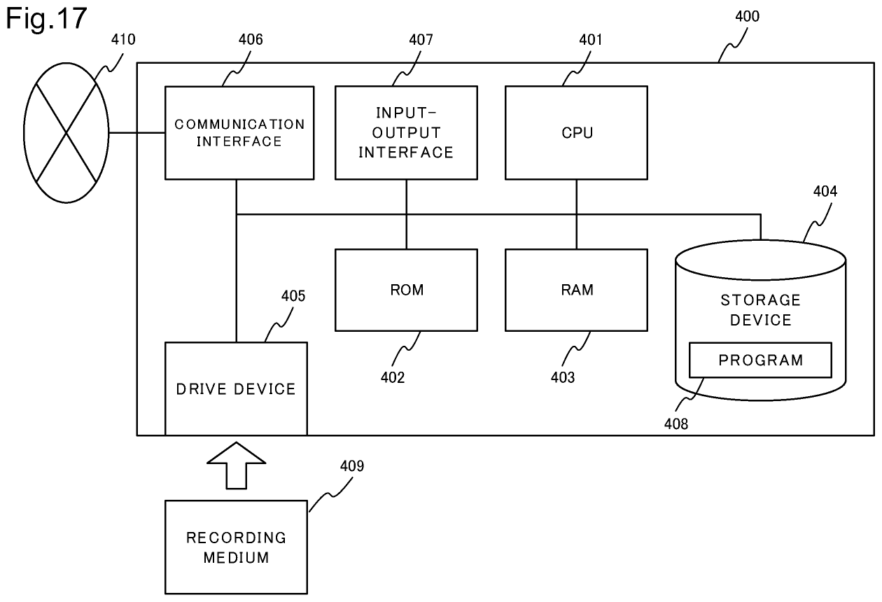

FIG. 17 is a block diagram illustrating an example of a hardware configuration of a computer device 400 that achieves the devices according to the present disclosure. The computer device 400 is configured including a central processing unit (CPU) 401, a read only memory (ROM) 402, a random access memory (RAM) 403, a storage device 404, a drive device 405, a communication interface 406, and an input-output interface 407.

The CPU 401 executes a program 408, using the RAM 403. The communication interface 406 exchanges data with an external device via a network 410. The input-output interface 407 exchanges data with peripheral devices (an input device, a display device, and the like). The communication interface 406 and the input-output interface 407 can function as constituent components for acquiring or outputting data.

Note that the program 408 may be stored in the ROM 402. In addition, the program 408 may be recorded in a recording medium 409, such as a memory card, and read by the drive device 405 or may be transmitted from an external device via the network 410.

The devices according to the present disclosure can be achieved by the configuration (or a portion thereof) illustrated in FIG. 17. For example, in the case of the server device 111, the control unit 121 corresponds to the CPU 401, the ROM 402, and the RAM 403. The storage unit 122 corresponds to the storage device 404 or the drive device 405. The communication unit 123 corresponds to the communication interface 406.

In addition, in the case of the terminal device 112, the control unit 141 corresponds to the CPU 401, the ROM 402, and the RAM 403. The storage unit 142 corresponds to the storage device 404 or the drive device 405. The communication unit 143 corresponds to the communication interface 406. The input unit 144, the output unit 145, the camera unit 146, and the sensor unit 147 correspond to external equipment connected via the input-output interface.

Note that the constituent components of the devices according to the present disclosure may be constituted by single circuitry (a processor or the like) or a combination of a plurality of pieces of circuitry. The circuitry referred to above may be either dedicated circuitry or general-purpose circuitry. For example, a portion and the other portion of the devices according to the present disclosure may be achieved by a dedicated processor and a general-purpose processor, respectively.

The components described as single devices in the above-described example embodiments may be disposed in a distributed manner to a plurality of devices. For example, the server device 111 or the information processing device 210 may be achieved by collaboration of a plurality of computer devices using a cloud computing technology and the like.

(2) The scope of application of the present disclosure is not limited to customer service assistance in a store. For example, the present disclosure can be applied to a system for assisting guidance about exhibits by a curator or an exhibitor to visitors to a museum, an art museum, an exhibition, and the like. Such a system can also be said to assist attendance (may be rephrased as escorting) to users visiting a predetermined facility with some purpose. In this case, the customer service information may be rephrased as guidance information, reception information, attendance information, and the like.

(3) The present invention was described above using the above-described example embodiments and variations as exemplary examples. However, the present invention is not limited to the example embodiments and variations. The present invention can include, within the scope of the present invention, example embodiments to which various modifications and applications that a so-called person skilled in the art can conceive are applied. In addition, the present invention can include an example embodiment that is constituted by appropriately combining or replacing matters described herein as needed basis. For example, matters described using a specific example embodiment can be applied to other example embodiments within an extent not causing inconsistency.

### 5: Supplementary Note

All or part of the embodiments described above can be described as in the following supplementary notes. However, the present invention is not limited to the aspects of the supplementary notes.

### Supplementary Note 1

A customer service assistance method comprising:

acquiring, from a terminal device held by a store clerk, location information that indicates a location of the terminal device in a store;

identifying a customer who is present in a predetermined range from the location in the store, using the location information and flow line information that indicates a movement history of the customer in the store;

generating customer service information relating to the identified customer, using the flow line information; and

outputting the generated customer service information to the terminal device.

### Supplementary Note 2

An information processing device comprising:

acquisition means for acquiring first information that indicates a location;

identification means for, using the first information, identifying an object that is present in a predetermined range from the location;

generation means for generating second information relating to the identified object, using third information that indicates a movement history of the object; and

output means for outputting the generated second information.

### Supplementary Note 3

The information processing device according to supplementary note 2, wherein

the third information includes information that indicates a movement history of each of a plurality of objects, and

the identification means, using the third information, identifies an object that is present in the predetermined range.

### Supplementary Note 4

The information processing device according to supplementary note 2 or 3, wherein

the first information indicates a location of a terminal device or a user of the terminal device,

the acquisition means acquires the first information and fourth information that indicates a direction of the terminal device or the user, and

the identification means identifies the object, based on the location indicated by the acquired first information and a direction identified by the acquired fourth information.

### Supplementary Note 5

The information processing device according to any one of supplementary notes 2 to 4, wherein

the object belongs to any of a plurality of groups, and

the identification means identifies an object that is present in the predetermined range and belongs to a specific group among the plurality of groups.

### Supplementary Note 6

The information processing device according to supplementary note 5, wherein

the identification means identifies, among objects belonging to the specific group, an object that is present in the predetermined range by excluding an object which satisfies a predetermined condition, the predetermined condition on the location relationship between the objects belonging to the specific group and an object belonging to a group different from the specific group.

### Supplementary Note 7

The information processing device according to any one of supplementary notes 2 to 6, wherein

the second information includes information identified based on the third information.

### Supplementary Note 8

The information processing device according to supplementary note 7, wherein

the generation means
identifies, among a plurality of areas, an area where the object had been present for a predetermined period of time or longer or an area where moving speed of the object fell lower than moving speed of the object in other areas, based on the third information and
generates the second information including information indicating the identified area.

### Supplementary Note 9

The information processing device according to supplementary note 7 or 8, wherein

the generation means

identifies a period of time for which the object had been present in an area, based on the third information and

generates the second information including information indicating the identified period of time.

### Supplementary Note 10

The information processing device according to any one of supplementary notes 2 to 9, wherein

the third information includes attribute information that indicates an attribute of the object associated with the movement history, and

the generation means generates the second information including the attribute information of the identified object.

### Supplementary Note 11

The information processing device according to any one of supplementary notes 2 to 10, wherein

the third information includes behavior information that indicates behavior of the object associated with the movement history, and

the generation means generates the second information including the behavior information of the identified object.

### Supplementary Note 12

A non-transitory recording medium recording a program causing a computer to execute:

acquisition processing of acquiring information that is information generated using a movement history of an object present in a predetermined range from a location of a terminal device or a user of the terminal device and relates to the object; and

output processing of outputting the acquired information and the object in association with each other.

### Supplementary Note 13

The recording medium according to supplementary note 12, wherein

the output processing includes processing of displaying the information in conjunction with an image captured including the object.

### Supplementary Note 14

The recording medium according to supplementary note 13, wherein

the output processing recognizes the object from the image and displays the information in conjunction with the image.

### Supplementary Note 15

The recording medium according to any one of supplementary notes 12 to 14, wherein

the output processing includes processing of displaying the information in conjunction with an image indicating a location of the object in a space.

### Supplementary Note 16

The recording medium according to any one of supplementary notes 12 to 15, wherein

the output processing includes processing of displaying the information in a display mode according to distance between the terminal device and the object.

### Supplementary Note 17

The recording medium according to any one of supplementary notes 12 to 16, wherein

the output processing includes processing of displaying the information in a display mode according to a period of time for which the object had been present in an area.

### Supplementary Note 18

A terminal device comprising:

acquisition means for acquiring information that is information generated using a movement history of an object present in a predetermined range from a location of the terminal device or a user of the terminal device and relates to the object; and

output means for outputting the acquired information and the object in association with each other.

### Supplementary Note 19

A non-transitory recording medium recording a program causing a computer to execute:

acquisition processing of acquiring first information that indicates a location;

identification processing of, using the first information, identifying an object that is present in a predetermined range from the location;

generation processing of generating second information relating to the identified object, using third information that indicates a movement history of the object; and

output processing of outputting the generated second information.

### Supplementary Note 20

An information processing method comprising:

acquiring first information that indicates a location;

using the first information, identifying an object that is present in a predetermined range from the location;

generating second information relating to the identified object, using third information that indicates a movement history of the object; and

outputting the generated second information.

### Supplementary Note 21

An information output method comprising:

acquiring information that is information generated using a movement history of an object present in a predetermined range from a location of a terminal device or a user of the terminal device and relates to the object; and outputting the acquired information and the object in association with each other.

### Supplementary Note 22

The information output method according to supplementary note 21, wherein

the output processing includes processing of displaying the information in conjunction with an image captured including the object.

### Supplementary Note 23

The information output method according to supplementary note 22, wherein

the output processing recognizes the object from the image and displays the information in conjunction with the image.

### Supplementary Note 24

The information output method according to any one of supplementary notes 21 to 23, wherein

the output processing includes processing of displaying the information in conjunction with an image indicating a location of the object in a space.

### Supplementary Note 25

The information output method according to any one of supplementary notes 21 to 24, wherein

the output processing includes processing of displaying the information in a display mode according to distance between the terminal device and the object.

### Supplementary Note 26

The information output method according to any one of supplementary notes 21 to 25, wherein

the output processing includes processing of displaying the information in a display mode according to a period of time for which the object had been present in an area.

### Supplementary Note 27

A customer service assistance method comprising:

acquiring, from a terminal device held by a store clerk, location information that indicates a location of the terminal device in a store;

identifying a customer who is present in a predetermined range from the location in the store, using the location information and flow line information that indicates a movement history of the customer in the store;

generating customer service information relating to the identified customer, using the flow line information; and

outputting the generated customer service information to the terminal device.

This application is based upon and claims the benefit of priority from Japanese Patent Application No. 2017-040660, filed on Mar. 3, 2017, the disclosure of which is incorporated herein in its entirety by reference.

### REFERENCE SIGNS LIST

110 Customer service assistance system
111 Server device
112 Terminal device
113 Recording device
114 Network
210 Information processing device
211 Acquisition unit
212 Identification unit
213 Generation unit
214 Output unit
310 Terminal device
311 Acquisition unit
312 Output unit
400 Computer device

1. A customer service assistance method comprising:
acquiring, from a terminal device held by a store clerk, location information that indicates a location of the terminal device in a store;
identifying a customer who is present in a predetermined range from the location in the store, using the location information and flow line information that indicates a movement history of the customer in the store;
generating customer service information relating to the identified customer, using the flow line information; and
outputting the generated customer service information to the terminal device.

2. An information processing device comprising:
at least one memory storing instructions; and
at least one processor configured to execute the instructions to perform:
acquiring first information that indicates a location;
identifying, using the first information, an object that is present in a predetermined range from the location;
generating second information relating to the identified object, using third information that indicates a movement history of the object; and
outputting the generated second information.

3. The information processing device according to claim 2, wherein
the third information includes information that indicates a movement history of each of a plurality of objects, and
the at least one processor is configured to perform:
identifying, using the third information, an object that is present in the predetermined range.

4. The information processing device according to claim 2, wherein
the first information indicates a location of a terminal device or a user of the terminal device,
the at least one processor is configured to perform:
acquiring the first information and fourth information that indicates a direction of the terminal device or the user, and
identifying the object, based on the location indicated by the acquired first information and a direction identified by the acquired fourth information.

5. The information processing device according to claim 2, wherein
the object belongs to any of a plurality of groups, and
the at least one processor is configured to perform:
identifying an object that is present in the predetermined range and belongs to a specific group among the plurality of groups.

6. The information processing device according to claim 5, wherein
the at least one processor is configured to perform:
identifying, among objects belonging to the specific group, an object that is present in the predetermined range by excluding an object which satisfies a predetermined condition, the predetermined condition on the location relationship between the objects belonging to the specific group and an object belonging to a group different from the specific group.

7. The information processing device according to claim 2, wherein
the second information includes information identified based on the third information.

8. The information processing device according to claim 7, wherein
the at least one processor is configured to perform:
identifying, among a plurality of areas, an area where the object had been present for a predetermined period of time or longer or an area where moving speed of the object fell lower than moving speed of the object in other areas, based on the third information and
generating the second information including information indicating the identified area.

9. The information processing device according to claim 7, wherein
the at least one processor is configured to perform:
identifying a period of time for which the object had been present in an area, based on the third information and
generating the second information including information indicating the identified period of time.

10. The information processing device according to claim 2, wherein
the third information includes attribute information that indicates an attribute of the object associated with the movement history, and
the at least one processor is configured to perform:
generating the second information including the attribute information of the identified object.

11. The information processing device according to claim 2, wherein
the third information includes behavior information that indicates behavior of the object associated with the movement history, and
the at least one processor is configured to perform:
generating the second information including the behavior information of the identified object.

12. A non-transitory recording medium recording a program causing a computer to execute:
acquisition processing of acquiring information that is information generated using a movement history of an object present in a predetermined range from a location of a terminal device or a user of the terminal device and relates to the object; and
output processing of outputting the acquired information and the object in association with each other.

13. The recording medium according to claim 12, wherein
the output processing includes processing of displaying the information in conjunction with an image captured including the object.

14. The recording medium according to claim 13, wherein
the output processing recognizes the object from the image and displays the information in conjunction with the image.

15. The recording medium according to claim 12, wherein
the output processing includes processing of displaying the information in conjunction with an image indicating a location of the object in a space.

16. The recording medium according to claim 12, wherein
the output processing includes processing of displaying the information in a display mode according to distance between the terminal device and the object.

17. The recording medium according to claim 12, wherein
the output processing includes processing of displaying the information in a display mode according to a period of time for which the object had been present in an area.

18.-21. (canceled)
